(19) United States
(12) Patent Application Publication
(10) Pub. No.: US 2018/0288218 A1
(43) Pub. Date: Oct. 4, 2018

(54) USER-DEFINED SEQUENCE OF EVENTS FOR MOBILE DEVICE ACTIONS

(71) Applicant: QUALCOMM Incorporated, San Diego, CA (US)

(72) Inventors: Naveen Kumar ARAVAPALLI, Hyderabad (IN); Prudhvi KOTHAPALLI, Hyderabad (IN); Suresh Kumar BITRA, Mangalagiri (IN)

(21) Appl. No.: 15/473,598

(22) Filed: Mar. 29, 2017

(51) Int. Cl. H04M 1/725

(52) U.S. Cl. CPC H04M 1/72583; H04M 1/72572; H04M 1/72577

(57) ABSTRACT

A method for initiating a mobile device action based on a user-defined sequence of events includes maintaining, at the mobile device, data representative of the user-defined sequence of events. The user-defined sequence of events is associated with an action to be performed by the mobile device. The user-defined sequence of events comprises multiple events and a particular order of occurrence of the multiple events in order to trigger the associated action. The method also includes detecting, at the mobile device, a second sequence of events and comparing the second sequence of events to the user-defined sequence of events. The action associated with the user-defined sequence of events is performed in response to the second sequence of events matching the user-defined sequence of events.

### FIELD OF DISCLOSURE

Aspects of this disclosure relate generally to telecommunications, and more particularly but not exclusively to initiating a mobile device action based on a user-defined sequence of events.

### BACKGROUND

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided by the Institute of Electrical and Electronics Engineers (IEEE), etc.

Due to the large variety of wireless communication system, often with overlapping coverage areas, the popularity of mobile devices that are capable of supporting multiple radio access technologies (RATs) has grown significantly. These mobile devices may have one or more radios for communication with multiple RATs.

Often there are situations where the user of a mobile device forgets the unlock password of the mobile device, misplaces the mobile device, and/or is unable to track a location of the mobile device. Existing solutions for these situations often require the mobile device to currently be connected to a Wi-Fi network and/or to have a secure connection (e.g., Bluetooth) to a trusted device. However, in some situations the mobile device may not be currently connected to such a Wi-Fi network, or may not be currently connected to a trusted device when the user wishes to unlock or locate the mobile device.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Aspects of the present disclosure include a method, a mobile device, and a non-transitory computer-readable medium for initiating a mobile device action based on a user-defined sequence of events. As will be described in further detail below, the mobile device action may include unlocking the mobile device, locking the mobile device, changing a profile mode of the mobile device, transmitting a location of the mobile device, and/or emitting an audio sound by the mobile device.

For example, according to one aspect, a method for initiating a mobile device action based on a user-defined sequence of events includes maintaining, at the mobile device, data representative of the user-defined sequence of events. The user-defined sequence of events is associated with an action to be performed by the mobile device. The user-defined sequence of events comprises multiple events and a particular order of occurrence of the multiple events in order to trigger the associated action. The method also includes detecting, at the mobile device, a second sequence of events and comparing the second sequence of events to the user-defined sequence of events. The action associated with the user-defined sequence of events is performed in response to the second sequence of events matching the user-defined sequence of events.

According to another aspect, a mobile device includes a processor and a memory coupled to the processor. The processor and the memory are configured to direct the mobile device to maintain data representative of a user-defined sequence of events. The user-defined sequence of events is associated with an action to be performed by the mobile device. The user-defined sequence of events comprises multiple events and a particular order of occurrence of the multiple events in order to trigger the associated action. The processor and memory are also configured to direct the mobile device to detect a second sequence of events and to compare the second sequence of events to the user-defined sequence of events. The action associated with the user-defined sequence of events is then performed in response to the second sequence of events matching the user-defined sequence of events.

In yet another aspect, a mobile device includes means for maintaining, at the mobile device, data representative of a user-defined sequence of events, the user-defined sequence of events associated with an action to be performed by the mobile device. The user-defined sequence of events comprises multiple events and a particular order of occurrence of the multiple events in order to trigger the associated action. The mobile device also includes means for detecting, at the mobile device, a second sequence of events, as well as a means for comparing the second sequence of events to the user-defined sequence of events. Furthermore, the mobile device includes a means for performing the action associated with the user-defined sequence of events in response to the second sequence of events matching the user-defined sequence of events.

Another aspect includes a non-transitory computer-readable storage medium that includes program code stored thereon. Instructions included in the program code are configured to direct a mobile device to maintain data representative of a user-defined sequence of events. The user-defined sequence of events is associated with an action to be performed by the mobile device. The user-defined sequence of events comprises multiple events and a particular order of occurrence of the multiple events in order to trigger the associated action. The instructions are also configured to direct the mobile device to detect a second sequence of events and to compare the second sequence of events to the user-defined sequence of events. The action associated with the user-defined sequence of events is then performed in response to the second sequence of events matching the user-defined sequence of events

Other objects and advantages associated with the aspects and examples disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1A illustrates a high-level system architecture of a wireless communications system, according to aspects of the present disclosure.

FIG. 1B illustrates functional components of an example mobile device, according to aspects of the present disclosure.

FIG. 2 illustrates an example mobile device when locked, according to aspects of the present disclosure.

FIG. 3 illustrates an example lock screen of a mobile device, according to aspects of the present disclosure.

FIG. 4 illustrates an example user interface accessible while the mobile device is locked, according to aspects of the present disclosure.

FIG. 5 illustrates data, maintained by a mobile device, related to one or more user-defined sequence of events, according to aspects of the present disclosure.

FIG. 6 illustrates an example sequence of events performed directly to a mobile device, according to aspects of the present disclosure.

FIG. 7 illustrates data, maintained by a mobile device, related to one or more user-defined sequence of events, where one or more of the events are communication events, according to aspects of the present disclosure.

FIG. 8 is a flow diagram illustrating an example method of initiating a mobile device action based on a user-defined sequence of events, according to aspects of the present disclosure.

FIG. 9 is illustrates an example mobile device represented as a series of interrelated functional modules.

### DETAILED DESCRIPTION

Aspects of the present disclosure are provided in the following description and related drawings directed to specific examples. Alternate examples may be devised without departing from the scope of the present disclosure. Additionally, well-known elements will not be described in detail or will be omitted so as not to obscure the relevant details of the present disclosure.

The words “exemplary” and/or “example” are used herein to mean “serving as an example, instance, or illustration.” Any aspect described herein as “exemplary” and/or “example” is not necessarily to be construed as preferred or advantageous over other examples. Likewise, the term “examples” or “aspects” does not require that all examples or aspects include the discussed feature, advantage or mode of operation.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects may be embodied in a number of different forms, all of which have been contemplated to be within the scope of the claimed subject matter. In addition, for each of the examples described herein, the corresponding form of any such embodiments may be described herein as, for example, “logic configured to” perform the described action.

A mobile device may be mobile or stationary, and may communicate with a radio access network (RAN). As used herein, the term “mobile device” may be referred to interchangeably as an “access terminal” or “AT”, a “wireless device”, a “user equipment”, a “subscriber device”, a “subscriber terminal”, a “subscriber station”, a “user terminal” or UT, a “mobile terminal”, a “mobile station” and variations thereof. Generally, mobile devices can communicate with a core network via the RAN, and through the core network the mobile devices can be connected with external networks such as the Internet. Of course, other mechanisms of connecting to the core network and/or the Internet are also possible for the mobile devices, such as over wired access networks, Wi-Fi networks (e.g., based on IEEE 802.11, etc.) and so on. Mobile devices can be embodied by any of a number of types of devices including but not limited to PC cards, compact flash devices, external or internal modems, wireless or wireline phones, and so on. A communication link through which mobile devices can send signals to the RAN is called an uplink channel (e.g., a reverse traffic channel, a reverse control channel, an access channel, etc.). A communication link through which the RAN can send signals to mobile devices is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel

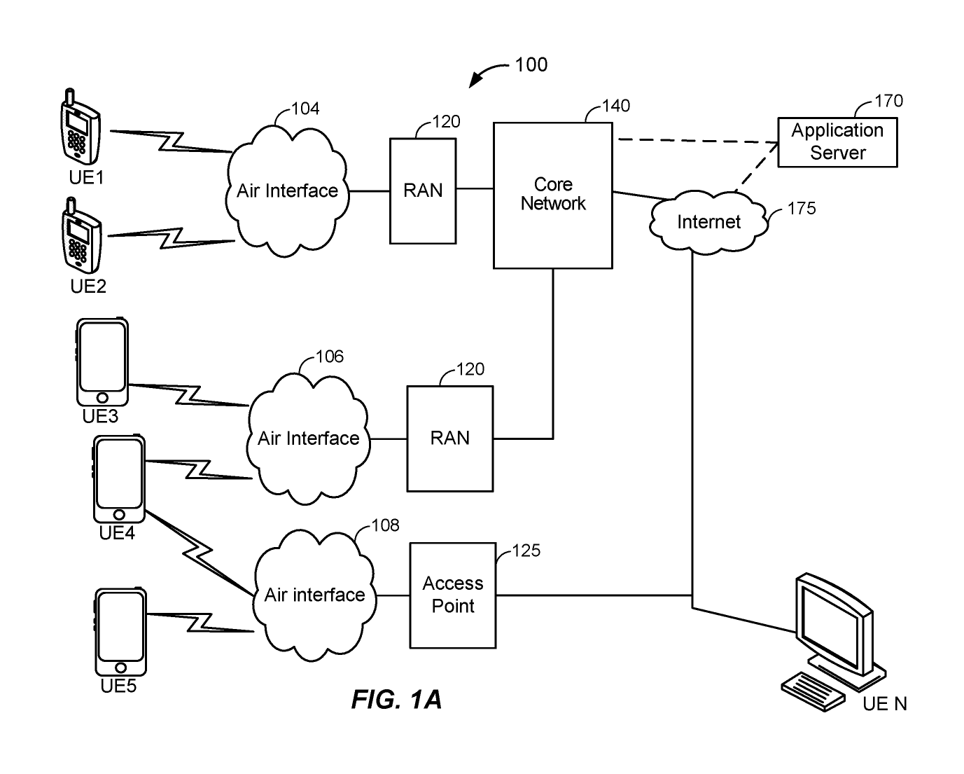

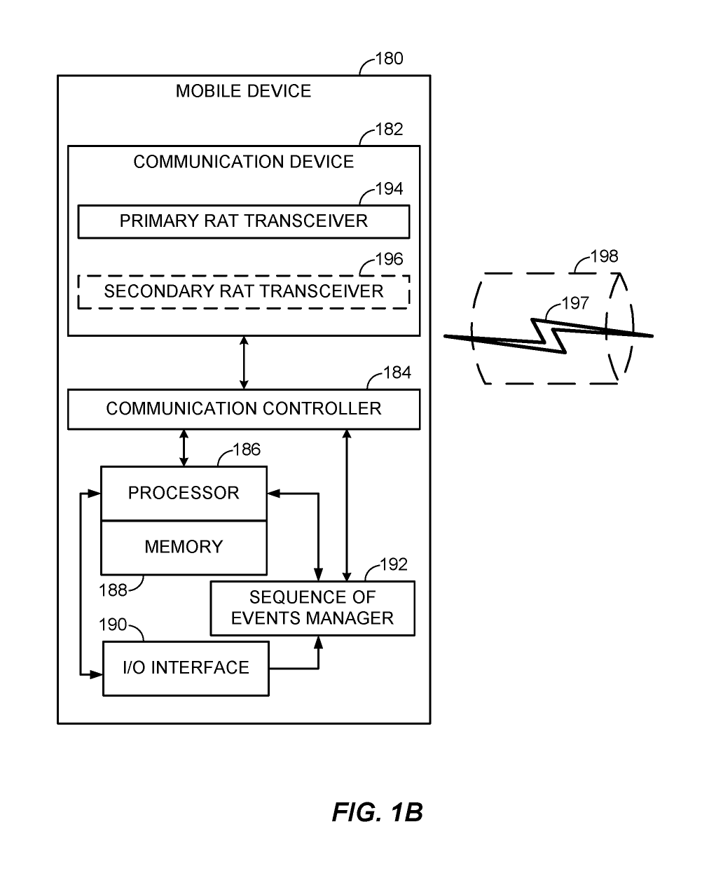

FIG. 1A illustrates a high-level system architecture of a wireless communications system 100. The wireless communications system 100 contains UEs 1 . . . N. The UEs 1 . . . N can include cellular telephones, personal digital assistant (PDAs), pagers, a laptop computer, a desktop computer, and so on. For example, in FIG. 1A, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1A, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA, EVDO, eHRPD, GSM, EDGE, W-CDMA, LTE, etc.), while the air interface 108 can comply with a wireless IP protocol (e.g., IEEE 802.11). The RAN 120 includes a plurality of access points that serve UEs over air interfaces, such as the air interfaces 104 and 106. The access points in the RAN 120 can be referred to as access nodes or ANs, access points or APs, base stations or BSs, Node Bs, eNode Bs, and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1A, UE N is shown as connecting to the Internet 175 directly (i.e., separate from the core network 140, such as over an Ethernet connection of Wi-Fi 33 or 802.11-based network). The Internet 175 can thereby function to bridge packet-switched data communications between UE N and UEs 1 . . . N via the core network 140. Also shown in FIG. 1A is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. UE N is shown as a desktop computer with a wired connection to the Internet 175, such as a direct connection to a modem or router, which can correspond to the access point 125 itself in an example (e.g., for a Wi-Fi router with both wired and wireless connectivity).

Referring to FIG. 1A, a server 170 is shown as connected to the Internet 175, the core network 140, or both. The server 170 can be implemented as a plurality of structurally separate servers, or alternately may correspond to a single server. The server 170 is configured to support one or more communication services (e.g., Voice-over-Internet Protocol (VoIP) sessions, Push-to-Talk (PTT) sessions, group communication sessions, social networking services, etc.) for UEs that can connect to the server 170 via the core network 140 and/or the Internet 175, and/or to provide content (e.g., web page downloads) to the UEs.

FIG. 1B illustrates functional components of an example mobile device 180, according to aspects of the present disclosure. Mobile device 180 is one possible implementation of any of the UEs 1-5 of FIG. 1B.

In the example of FIG. 1B, the mobile device 180 includes a wireless communication device 182 for communicating with other network nodes via at least one designated RAT. The communication device 182 may be variously configured for transmitting and encoding signals (e.g., messages, indications, information, and so on), and, conversely, for receiving and decoding signals (e.g., messages, indications, information, pilots, and so on) in accordance with the designated RAT. The mobile device 180 may also include a communication controller 184 for controlling operation of communication device 182 (e.g., directing, modifying, enabling, disabling, etc.). The communication controller 184 may operate at the direction of or otherwise in conjunction with respective host system functionality (illustrated as the processor 186 and the memory 188). In some designs, the communication controller 184 may be partly or wholly subsumed by the respective host system functionality.

Turning to the illustrated communication in more detail, the mobile device 180 may transmit and receive messages via a wireless link 197 with a RAN or an access point, the message including information related to various types of communication (e.g., voice, data, multimedia services, associated control signaling, etc.). The wireless link 197 may operate over a communication medium of interest, shown by way of example in FIG. 1B as the medium 198, which may be shared with other communications as well as other RATs. A medium of this type may be composed of one or more frequency, time, and/or space communication resources (e.g., encompassing one or more channels across one or more carriers) associated with communication between one or more transmitter/receiver pairs, the mobile device 180 and one or more of the RANs of FIG. 1A for the medium 198.

As a particular example, the medium 198 may correspond to at least a portion of an unlicensed frequency band shared with other RATs. In general, the mobile device 180 may operate via the wireless link 197 according to one or more RATs depending on the network in which it is deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by Wireless Local Area Network (WLAN) technologies, most notably IEEE 802.11x WLAN technologies generally referred to as “Wi-Fi.”

In the example of FIG. 1B, the communication device 182 includes a primary RAT transceiver 194 configured to operate in accordance with one RAT and, in some designs, an optional secondary RAT transceiver 196 configured to operate in accordance with another RAT. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a receiver chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The primary RAT transceiver 194 and the secondary RAT transceiver 196 may provide different functionalities and may be used for different purposes. As an example, the primary RAT transceiver 194 may operate in accordance with Wi-Fi technology to provide communication with an access terminal on the wireless link 197, while the secondary RAT transceiver 196 (if equipped) may operate in accordance with Long Term Evolution (LTE) technology to monitor LTE signaling on the medium 198 that may interfere with or be interfered with by the Wi-Fi communications. The secondary RAT transceiver 196 may or may not serve as a full LTE eNB providing communication services to a corresponding network.

In some implementations, the mobile device 180 can receive and execute software applications, data and/or commands transmitted over a network interface, such as air interface 108 in FIG. 1A and/or a wired interface. The mobile device 180 can also independently execute locally stored applications. As discussed above, the communication device 182 can include one or more transceivers configured for wired and/or wireless communication (e.g., a Wi-Fi transceiver, a Bluetooth transceiver, a cellular transceiver, a satellite transceiver, a GPS or SPS receiver, etc.) operably coupled to one or more processors 186, such as a microcontroller, microprocessor, application specific integrated circuit, digital signal processor (DSP), programmable logic circuit, or other data processing device, which will be generally referred to as processor 186. The processor 186 can execute application programming instructions within a memory 188 of the mobile device 180. The memory 188 can include one or more of read-only memory (ROM), random-access memory (RAM), electrically erasable programmable ROM (EEPROM), flash cards, or any memory common to computer platforms. One or more input/output (I/O) interfaces 190 can be configured to allow the processor 186 to communicate with and control from various I/O devices such as a display, one or more peripheral buttons/switches, and any other devices, such as sensors, actuators, relays, valves, switches, and the like associated with the mobile device 180.

As will be discussed in more detail below, the mobile device 180 may further include a sequence of events manager 192. In general, the sequence of events manager 192 may maintain data representative of a user-defined sequence of events as well as an associated action to be performed by the mobile device 180, should the sequence of events be subsequently detected by the mobile device 180. In some examples, the sequence of events manager 192 may operate in conjunction with the communication device 182, the processor 186, the memory 188, and/or the I/O interface 190 to (1) maintain the user-defined sequence of events, (2) subsequently detect a sequence of events, (3) compare the detected sequence of events with the user-defined sequence of events, and (3) to perform the action associated with the user-defined sequence of events.

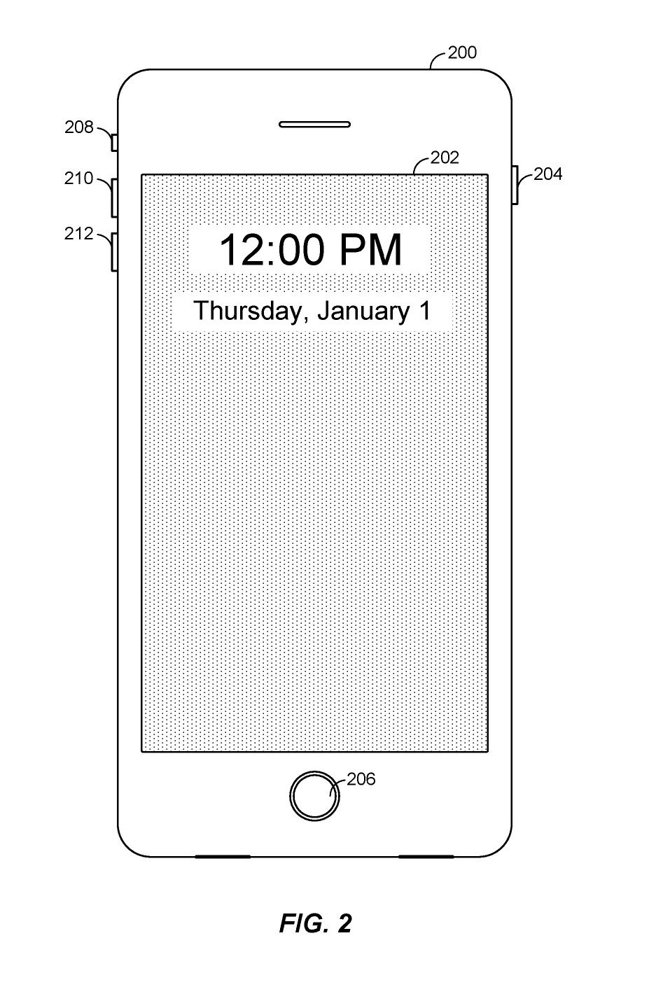

FIG. 2 illustrates an example mobile device 200, according to aspects of the present disclosure. Mobile device 200 is one possible implementation of any of the UEs 1-5 of FIG. 1A and/or the mobile device 180 of FIG. 1B. As shown in FIG. 2, in an example configuration for the mobile device 200, an external casing of mobile device 200 may include a display 202. In one example, the display 202 is a touchscreen display. The external casing of the mobile device 200 may further include one or more physical peripheral buttons/switches 204-212. In particular, peripheral button 204 may be a power button, peripheral button 206 may be referred to as a home button, peripheral switch 208 may be a silent mode switch, button 210 may be an increase volume button, and button 212 may be a decrease volume button. While not shown explicitly as part of mobile device 200, the mobile device 200 may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

In some situations, a user of the mobile device 200 may lock the mobile device 200. In other situations, the mobile device 200 may lock automatically, based on one or more triggers, such as a power on event or a timer. Locking of the mobile device 200 may allow the mobile device 200 to remain powered on, but to restrict access to the applications and/or data stored on the mobile device 200 to only one or more designated users. When locked, the mobile device 200 may limit the functionality and/or information that is presented via the display 202. In some instances, when locked, the mobile device 200 may still provide some information on the display 202 such as the time or date, alerts, notifications, reminders, as well as other information as may be configured by the user. However, when locked, the mobile device 200 may typically prevent the launching of most applications, and/or the viewing of stored data (e.g., pictures, contacts, etc.).

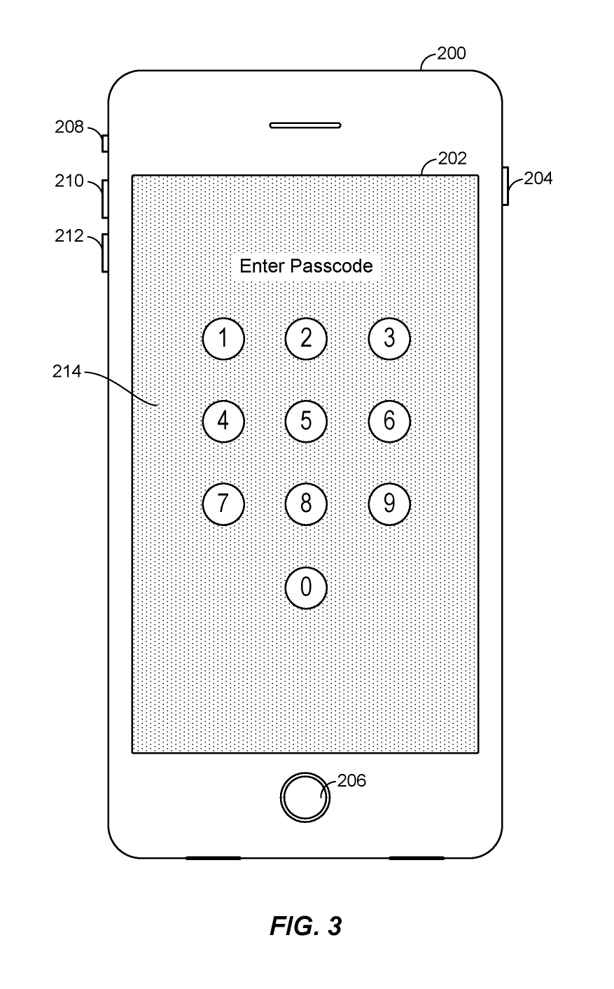

In order to unlock the mobile device 200, the user may be required to enter a passcode. Thus, the mobile device 200 may be configured to present a lock screen via the display 202 to allow the user to enter the passcode to unlock the mobile device 200. FIG. 3 illustrates an example lock screen 214 of mobile device 200, according to aspects of the present disclosure. In some implementations, the passcode may be four or more digits. Thus, the user may enter the passcode via the lock screen 214 to unlock the mobile device 200. However, as mentioned above there may be situations where the user forgets or otherwise cannot recall the passcode. Accordingly, as will be described below, one aspect of the present disclosure may allow the user to define a sequence of events other than having the user enter the passcode that will enable the user to unlock the mobile device 200. For example, the user-defined sequence of events may include actions performed by the user directly to the mobile device 200, such as pressing or switching a particular sequence of the physical peripheral buttons/switches 204-212.

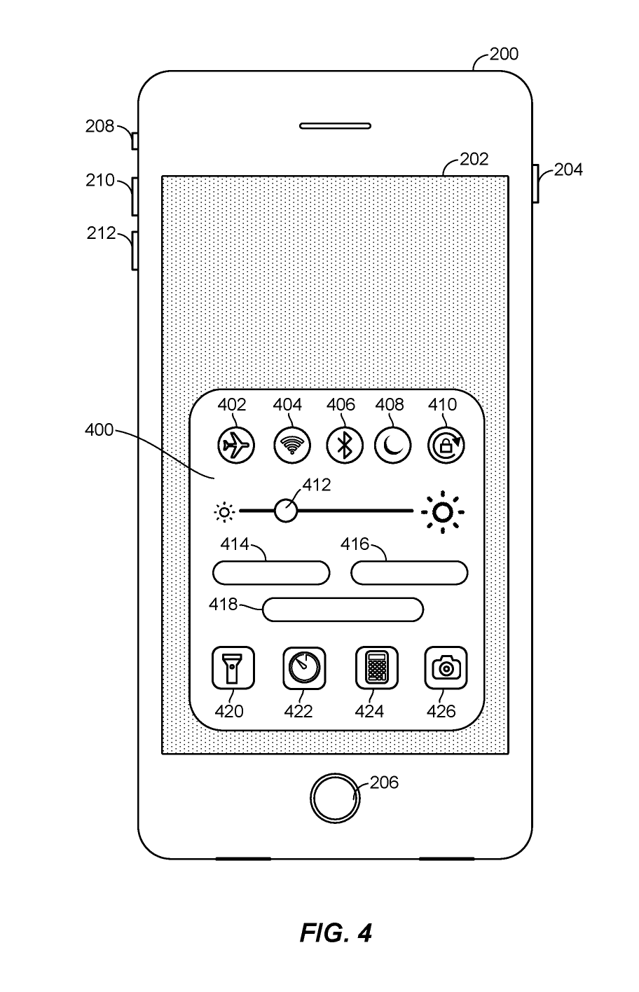

As mentioned above, when locked, the mobile device 200 may typically prevent the launching of most applications, and/or the viewing of stored data (e.g., pictures, contacts, etc.). However, the mobile device 200 may still allow certain functionality and/or access to certain settings while the mobile device 200 is locked. By way of example, FIG. 4 illustrates an example user interface 400 that is accessible while the mobile device 200 is locked, according to aspects of the present disclosure. As shown in FIG. 4, user interface 400 includes several user interface elements 402-426. In particular, user interface elements 402-410 and 414-426 are presented as virtual buttons, and element 412 is presented as a virtual slider. Although FIG. 4 only illustrates virtual buttons and a virtual slider other user interface elements may be incorporated into the user interface 400 such as virtual toggle buttons, steppers, pull-down menus, pickers, text fields, etc. In normal operation, each of the user interface elements 402-412 are configured to have a corresponding function associated it. For example, virtual button 402 may be configured to toggle an airplane mode of the mobile device 200, virtual button 404 may be configured to enable/disable the Wi-Fi transceiver of the mobile device 200, virtual button 406 may be configured to enable/disable a Bluetooth transceiver of the mobile device 200, virtual button 406 may be configured to enable/disable a rotation lock of the display 202, virtual button 408 may be configured to enable/disable a do not disturb mode of the mobile device 200, virtual button 410 may be configured to enable/disable a screen orientation lock of display 202, virtual slider 412 may be configured to allow the adjustment of the brightness of the display 202, virtual button 420 may activate a flashlight mode of the mobile device 200 (i.e., turn on a flash associated with a camera incorporated into the mobile device), virtual button 422 may launch a timer/alarm application, virtual button 424 may launch a calculator application, and virtual button 426 may launch a camera application to allow a user to take one or more pictures with the mobile device.

Accordingly, in addition to, or in lieu of the user-defined sequence of events including actions such as pressing or switching the physical peripheral buttons/switches 204-212, aspects of the present disclosure may allow the user to incorporate one or more events to the user-defined sequence of events such as pressing, toggling, or otherwise activating a virtual user interface element, such as virtual user interface elements 402-426. For example, the user-defined sequence of events may include actions performed by the user directly to the mobile device 200, such as (1) pressing or switching a particular sequence of the physical peripheral buttons/switches 204-212, (2) activating a particular sequence of the virtual user interface elements 402-426, or (3) a particular sequence that includes user actions utilizing at least one physical peripheral buttons/switches and at least one virtual user interface element.

As discussed above, with reference to FIG. 1B, a mobile device according to the present disclosure may include a sequence of events manager 192 that is configured to maintain data that is representative of a user-defined sequence of events as well as an associated action to be performed by the mobile device, should the sequence of events be subsequently detected. In one aspect, the sequence of events manager 192 may provide a user interface via display 202 to allow the user to define or otherwise select an action and an associated sequence of events. In one example, the sequence of events includes multiple events and a particular order of occurrence of the multiple events in order to trigger the associated action (e.g., unlock the mobile device). In one example, maintaining the data may include receiving the user-defined sequence of events and associated action from the user and storing it in memory (e.g., memory 188). In one aspect, the sequence of events includes three or more events (i.e., at least three events) and a particular order of the three or more events.

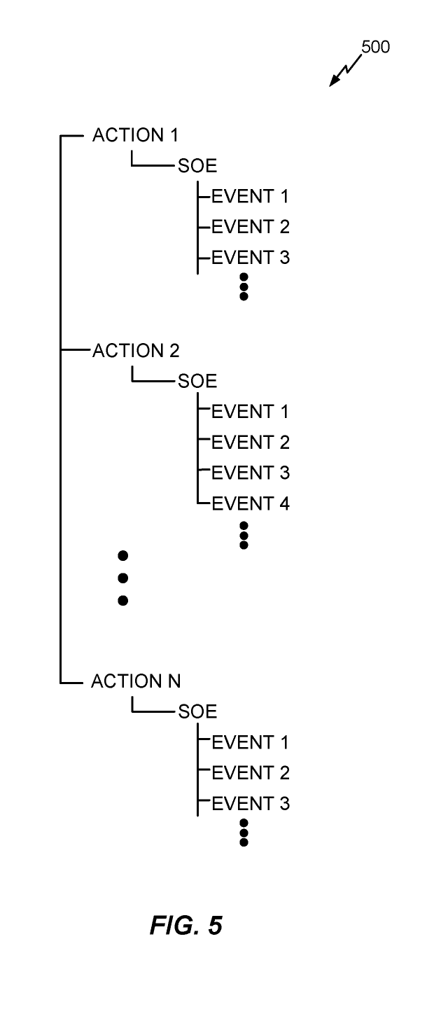

FIG. 5 illustrates example data 500, maintained by a mobile device, related to one or more user-defined sequence of events, according to aspects of the present disclosure. As shown in FIG. 5, the data may include one or more actions 1-N that may be performed by the mobile device. For example, as mentioned above the action may include the unlocking of the mobile device. However, other actions may be implemented consistent with the present disclosure, such as changing a profile mode of the mobile device, transmitting a current location of the mobile device, and/or emitting an audio sound by the mobile device. Furthermore, the data may include the same action repeated, but each with a different sequence of events for each. For example, the user may define a first sequence of events in order to unlock the mobile device and may also define a second sequence of events, different from the first, that also unlocks the mobile device.

As further shown in FIG. 5 each of the illustrated actions 1-N includes an associated sequence of events (SOE), where each SOE indicates multiple (e.g., at least three events) and a particular order of occurrence of the multiple events. For example, Event 1 must occur first, followed by Event 2, and so on in order to trigger the associated action. The events included in a SOE may include user actions that are performed directly to the mobile device while the mobile device is locked, such as the user pressing/toggling a physical peripheral button (e.g., one or more physical peripheral buttons 204-212). An event may also include the user activating or otherwise interacting with a virtual user interface element, such as virtual user interface elements 402-426. By way of example an event may include pressing of the power button 204, pressing the home button 206, toggling the silent mode switch 208, pressing the increase volume button 210, pressing the decrease volume button 212, enabling or disabling an airplane mode via virtual button 402, enabling or disabling a Wi-Fi mode via virtual button 404, enabling or disabling a Bluetooth mode via virtual button 406, enabling or disabling a do not disturb mode via virtual button 408, enabling or disabling a screen orientation lock via virtual button 410, adjusting a screen brightness via virtual slider 412, enabling or disabling a flashlight mode via virtual button 420, launching a timer application via virtual button 422, launching a calculator application via virtual button 424, and launching a camera application via virtual button 426. Further events may be defined by the user that provide for more complex actions to be performed by the user. For example, further events that may be included in a SOE may include, setting the screen brightness to 100% via virtual slider 412, setting the screen brightness to 0% via virtual slider 412, and/or taking a screen shot by simultaneously pressing one or more of the physical peripheral buttons 204-212.

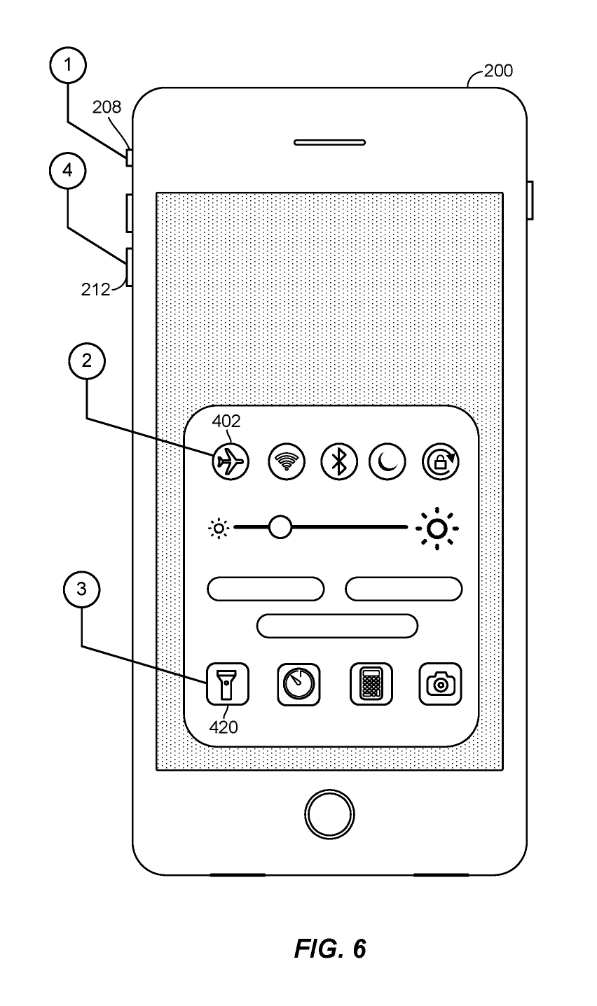

FIG. 6 illustrates an example sequence of events (1)-(4) that include actions performed directly to mobile device 200, according to aspects of the present disclosure. The sequence of events illustrated in FIG. 6 is one possible implementation of the sequence of events associated with Action 2 of FIG. 5. In this example, Action 2 may be an action to be performed by the mobile device 200, such as the unlocking of the mobile device 200. As shown in FIG. 6 a first event (1) may include the user toggling the silent mode switch 208. A second event (2) may include the toggling an airplane mode by the user pressing the virtual button 402. A third event (3) may include the user enabling or disabling a flashlight mode by pressing the virtual button 420. A fourth event (4) may include the user pressing the decrease volume button 212. Although the illustrated example of a sequence of event provides a sequence that include four user-defined events, aspects of the present disclosure may include a sequence of events that include any number of events including 3 or more events.

The example sequence of events of FIG. 6 includes events that define actions that are performed directly to the mobile device 200 by a user. However, as mentioned above, there may be situations where the user misplaces the mobile device. Furthermore, there may be situations where the user is unable to track a location of the mobile device because the required communications network (e.g., Wi-Fi) is unavailable. Thus, aspects of the present disclosure may include a user-defined sequence of events that includes communication events that are received from another device. In one aspect, a communication event may include any communication that is received at communication device 182 from another device via wireless link 197 (see FIG. 1B). For example, a communication event may be a ‘missed call’, a ‘received text message’, a ‘missed call’ from a user-defined trusted mobile device, a “received text message' from a user-defined trusted mobile device, a ‘received text message’ having a predefined string of text, or a ‘received text message’ having a predefined string of text from a user-defined trusted mobile device.

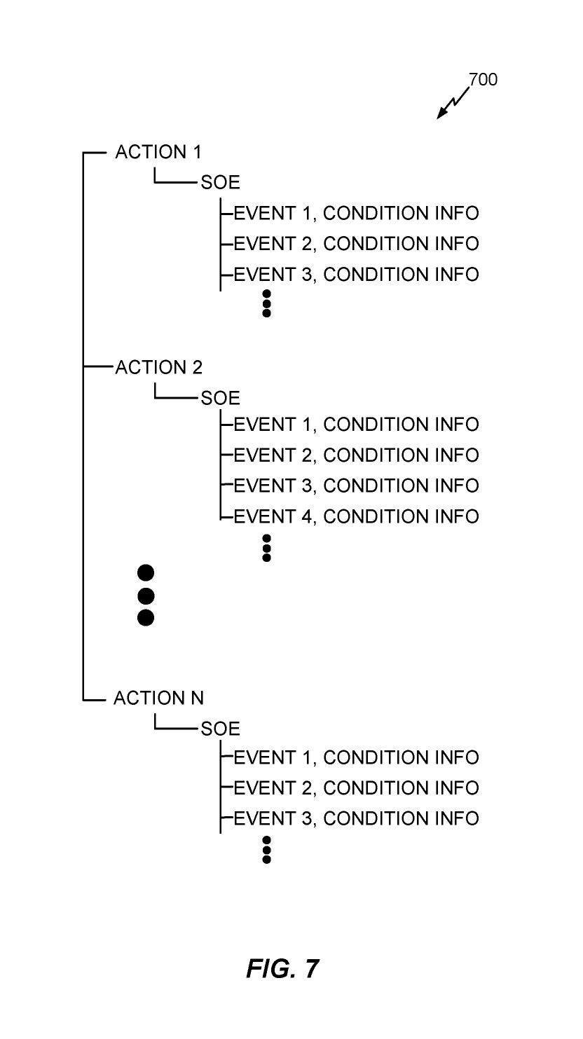

FIG. 7 illustrates data, maintained by a mobile device, related to one or more user-defined sequence of events, where one or more of the events are communication events, according to aspects of the present disclosure. As shown in FIG. 7, the data may include one or more actions 1-N that may be performed by the mobile device. For example, as mentioned above the action may include the unlocking of the mobile device. However, other actions may be implemented consistent with the present disclosure, such as locking the mobile device, changing a profile mode of the mobile device, transmitting a current location of the mobile device, and/or emitting an audio sound by the mobile device. Furthermore, the data may include the same action repeated, but each with a different sequence of events. For example, the user may define a first sequence of events in order to lock the mobile device and may also define a second sequence of events, different from the first, that also locks the mobile device.

As further shown in FIG. 7 each of the illustrated actions 1-N includes an associated sequence of events (SOE), where each SOE indicates multiple (e.g., at least three) communication events and a particular order of occurrence of the multiple communication events. For example, Event 1 must occur first, followed by Event 2, and so on in order to trigger the associated action. The events included in a SOE may include communication events that are received by a transceiver (e.g., see communication device 182 of FIG. 1B) from another device. As mentioned above a communication event may include a ‘missed call’ or a ‘received text message’. A communication event may also include associated condition information that is defined by the user. For example, the condition information may identify a phone number of a user-defined trusted mobile device. Thus, an event such as a missed call may only be recognized as a valid event if the missed call is received from the phone number of the user-defined trusted mobile device. Similarly, the condition information may identify a particular string of text that must be present in the text message in order for the text message to be recognized as a valid event. Accordingly, the sequence of events manager 192 may provide a user interface via display 202 to allow the user to define or otherwise select an action, an associated sequence of events, and optionally the condition information (e.g., phone number or string of text) associated with each event.

By way of illustration, the example Action 1 of FIG. 7 may correspond to an action to lock the mobile device and where the associated sequence of events (SOE) includes an event (1) of ‘Missed Call’, and event (2) of ‘Received Text Message, and an event (3) of ‘Missed Call’. Thus, during operation if a missed call is received, followed by a received text message, followed by another missed call the mobile device will automatically lock. As will be discussed further below, the sequence of events manager 192 may also monitor and detect for sequences of events that match the user-defined sequence of events. In some implementations if the time between detected events is greater than a threshold amount of time and/or if an intervening event is detected, the detected events may be determined to not match the user-defined sequence of events.

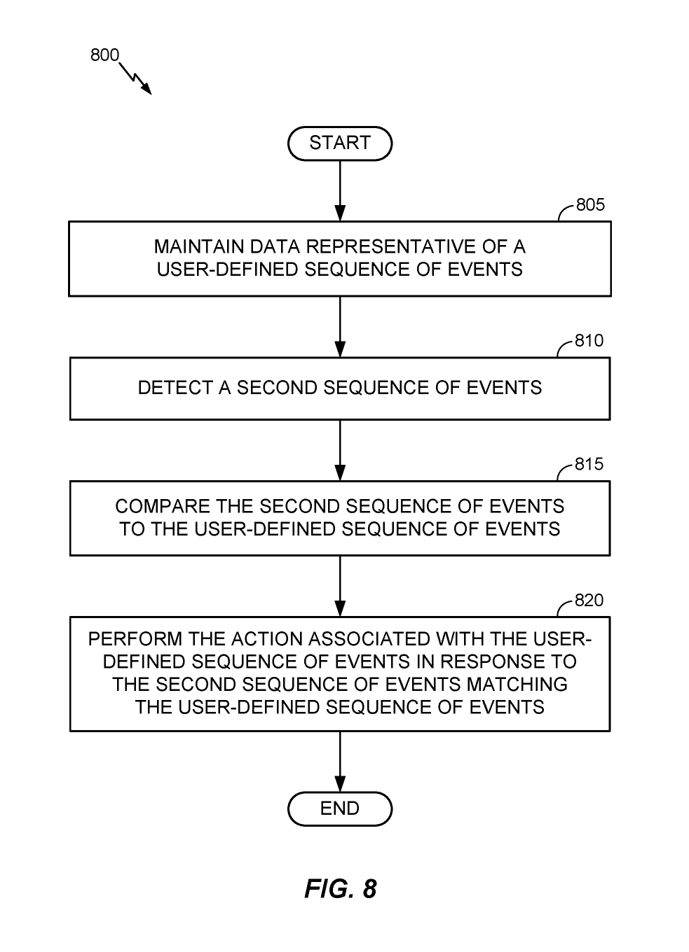

FIG. 8 is a flow diagram illustrating an example process 800 of initiating a mobile device action based on a user-defined sequence of events, according to aspects of the present disclosure. Process 800 is one possible process performed by UEs 1-5 of FIG. 1A, mobile device 180 of FIG. 1B, and/or mobile device 200 of FIG. 2.

In process block 805, the mobile device 180 maintains data representative of a user-defined sequence of events and an associated action. As discussed above, the sequence of events manager 192 may present a user interface to the user via display 202 to allow the user to select or otherwise enter one or more actions and their associated sequence of events. The sequence of events manager 192 may then store/save the data (e.g., data 500 of FIG. 5 and/or data 700 of FIG. 7) to memory 188. The user-defined sequence of events includes multiple (e.g., three or more) events and a particular order of occurrence of the multiple events in order to trigger the associated action.

In process block 810, the sequence of events manager 192 may detect, at the mobile device, a second sequence of events. In one example, the sequence of events manager 192 is communicatively coupled to I/O interface 190 such that the sequence of events manager 192 may detect user actions that are performed directly to the mobile device 180, such as the pressing of physical peripheral buttons 204-212 and/or the use of any virtual user interface elements, such as virtual buttons 402-426. The sequence of events manager 192 may also be communicatively coupled to the communication device 182 via communication controller 184 such that the sequence of events manager 192 may detect communication events that are received by at least one of the transceivers.

In process block 815, the sequence of events manager 192 compares the second sequence of events to the user-defined sequence of events to determine whether there is a match. In one example, in order for two detected events to be considered a match to two corresponding user-defined events of a particular sequence, the two detected events must occur within a threshold amount of time of one another and the second detected event must be immediately subsequent to the first detected event. That is, a intervening event would render the detected events as not matching the user-defined sequence of events.

Next, in process block 820 the mobile device performs the action associated with the user-defined sequence of events in response to the second sequence of events matching the user-defined sequence of events. As discussed above, the action performed by the mobile device may include unlocking the mobile device, locking the mobile device, changing a profile mode of the mobile device, transmitting a current location of the mobile device, and emitting an audio sound. In one aspect, changing a profile mode of the mobile device may include enabling a ‘guest mode’ of the mobile device to allow limited access to software applications and/or hardware functionalities. For example, in a scenario where a phone is lost or misplaced a user may want to remotely enable the guest mode to allow someone who finds the phone to have limited functionality (e.g., enable the mobile device to make limited outgoing calls, enable the mobile device to send limited text messages, etc.) to provide the ability to contact the user should they find the phone, but to still protect sensitive data and/or applications. In one aspect, transmitting a current location of the mobile device includes invoking a positioning session (e.g., GPS/location session) and transmitting the position info and an identity of the mobile device (e.g., International Mobile Equipment Identity (IMEI) and/or International Mobile Subscriber Identity (IMSI)).

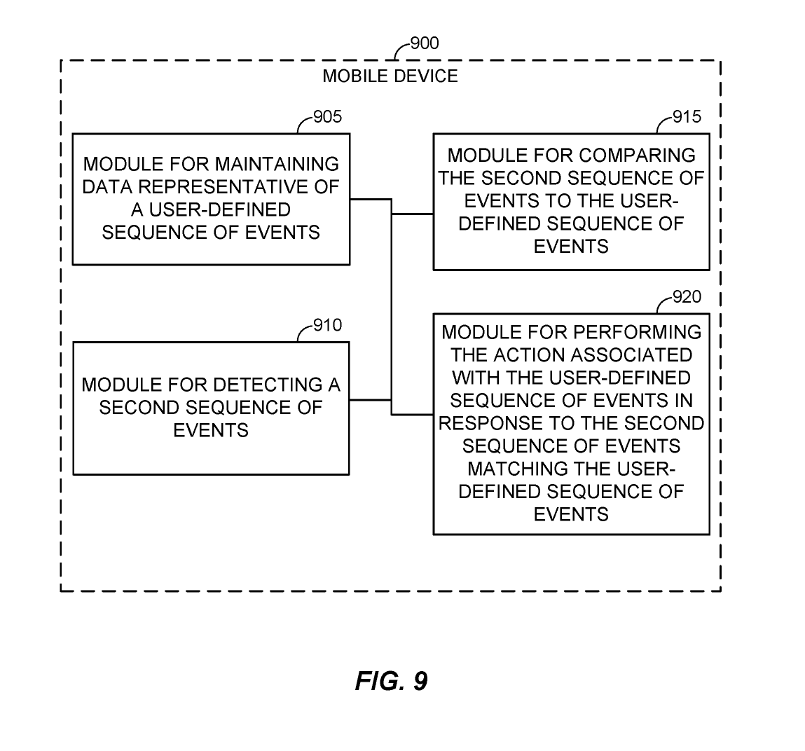

FIG. 9 is illustrates an example mobile device 900 represented as a series of interrelated functional modules. A module 905 for maintaining data representative of a user-defined sequence of events may correspond at least in some aspects to, for example, a sequence of events manager 192, processor 186, memory 188 and/or I/O interface 190 as discussed above with reference to FIG. 1B. A module 910 for detecting a second sequence of events may correspond at least in some aspects to, for example, a communication device 182, a sequence of events manager 192, processor 186, memory 188 and/or I/O interface 190 as discussed above with reference to FIG. 1B. A module 915 for comparing the second sequence of events to the user-defined sequence of events may correspond at least in some aspects to, for example, a sequence of events manager 192, processor 186, and/or memory 188 as discussed above with reference to FIG. 1B. A module 920 performing the action associated with the user-defined sequence of events in response to the second sequence of events matching the user-defined sequence of events may correspond at least in some aspects to, for example, a communication device 182, a sequence of events manager 192, processor 186, memory 188 and/or I/O interface 190 as discussed above with reference to FIG. 1B.

The functionality of the modules of FIG. 9 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 9, as well as other components and functions described herein, may be implemented using any suitable means. Such means also may be implemented, at least in part, using corresponding structure as taught herein. For example, the components described above in conjunction with the “module for” components of FIG. 9 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a method for initiating a mobile device action based on a user-defined sequence of events.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method, comprising:
maintaining, at a mobile device, data representative of a user-defined sequence of events, the user-defined sequence of events associated with an action to be performed by the mobile device, wherein the user-defined sequence of events comprises multiple events and a particular order of occurrence of the multiple events in order to trigger the associated action;
detecting, at the mobile device, a second sequence of events;
comparing the second sequence of events to the user-defined sequence of events; and
performing, at the mobile device, the action associated with the user-defined sequence of events in response to the second sequence of events matching the user-defined sequence of events.

2. The method of claim 1, wherein the action includes at least one action selected from the group comprising of: unlocking the mobile device, locking the mobile device, changing a profile mode of the mobile device, transmitting a current location of the mobile device, or emitting an audio sound.

3. The method of claim 1, wherein detecting the second sequence of events comprises receiving a sequence of communication events from another device.

4. The method of claim 3, wherein the sequence of communication events includes a combination of at least one communication event selected from the group comprising of: a missed call, a received text message, or a received text message having a predefined string of text.

5. The method of claim 3, further comprising:
maintaining, at the mobile device, a phone number of a user-defined trusted device, wherein performing the action at the mobile device comprises performing the action only if the sequence of communication events are received from the phone number of the trusted device.

6. The method of claim 1, wherein the user-defined sequence of events comprises user actions performed directly to the mobile device while the mobile device is locked.

7. The method of claim 6, wherein the mobile device is configured to unlock in response to a passcode entered via a lock screen of the mobile device, and wherein the user-defined sequence of events includes user actions other than entering the passcode.

8. The method of claim 7, wherein the user-defined sequence of events comprises at least one user action selected from the group comprising of: pressing a power button, pressing a home button, toggling a silent mode switch, pressing an increase volume button, pressing a decrease volume button, enabling or disabling an airplane mode via a virtual button, enabling or disabling a Wi-Fi mode via a virtual button, enabling or disabling a Bluetooth mode via a virtual button, enabling or disabling a do not disturb mode via a virtual button, enabling or disabling a screen orientation lock via a virtual button, adjusting a screen brightness via virtual slider, enabling or disabling a flashlight mode via a virtual button, launching a timer application via a virtual button, launching a calculator application via a virtual button, launching a camera application via a virtual button, setting the screen brightness to 100% via the virtual slider, setting the screen brightness to 0% via the virtual slider, or taking a screen shot by simultaneously pressing one or more physical peripheral buttons.

9. A mobile device, comprising:
a processor; and
a memory coupled to the processor, wherein the processor and the memory are configured to direct the mobile device to:
maintain, at the mobile device, data representative of a user-defined sequence of events, the user-defined sequence of events associated with an action to be performed by the mobile device, wherein the user-defined sequence of events comprises multiple events and a particular order of occurrence of the multiple events in order to trigger the associated action;
detect, at the mobile device, a second sequence of events;
compare the second sequence of events to the user-defined sequence of events; and
perform, at the mobile device, the action associated with the user-defined sequence of events in response to the second sequence of events matching the user-defined sequence of events.

10. The mobile device of claim 9, wherein the action includes at least one action selected from the group comprising of: unlocking the mobile device, locking the mobile device, changing a profile mode of the mobile device, transmitting a current location of the mobile device, or emitting an audio sound.

11. The mobile device of claim 9, wherein the second sequence of events comprises a sequence of communication events, and wherein the processor and the memory are further configured to receive the sequence of communication events from another device.

12. The mobile device of claim 11, wherein the sequence of communication events includes a combination of at least one communication event selected from the group comprising of: a missed call, a received text message, or a received text message having a predefined string of text.

13. The mobile device of claim 11, wherein the processor and the memory are further configured to direct the mobile device to:
maintain, at the mobile device, a phone number of a user-defined trusted device; and
perform the action only if the sequence of communication events are received from the phone number of the trusted device.

14. The mobile device of claim 9, wherein the user-defined sequence of events comprises user actions performed directly to the mobile device while the mobile device is locked.

15. The mobile device of claim 14, wherein the mobile device is configured to unlock in response to a passcode entered via a lock screen of the mobile device, and wherein the user-defined sequence of events includes user actions other than entering the passcode.

16. The mobile device of claim 15, wherein the user-defined sequence of events comprises at least one user action selected from the group comprising of: pressing a power button, pressing a home button, toggling a silent mode switch, pressing an increase volume button, pressing a decrease volume button, enabling or disabling an airplane mode via a virtual button, enabling or disabling a Wi-Fi mode via a virtual button, enabling or disabling a Bluetooth mode via a virtual button, enabling or disabling a do not disturb mode via a virtual button, enabling or disabling a screen orientation lock via a virtual button, adjusting a screen brightness via virtual slider, enabling or disabling a flashlight mode via a virtual button, launching a timer application via a virtual button, launching a calculator application via a virtual button, launching a camera application via a virtual button, setting the screen brightness to 100% via the virtual slider, setting the screen brightness to 0% via the virtual slider, or taking a screen shot by simultaneously pressing one or more physical peripheral buttons.

17. A mobile device, comprising:
means for maintaining, at the mobile device, data representative of a user-defined sequence of events, the user-defined sequence of events associated with an action to be performed by the mobile device, wherein the user-defined sequence of events comprises multiple events and a particular order of occurrence of the multiple events in order to trigger the associated action;
means for detecting, at the mobile device, a second sequence of events;
means for comparing the second sequence of events to the user-defined sequence of events; and
means for performing, at the mobile device, the action associated with the user-defined sequence of events in response to the second sequence of events matching the user-defined sequence of events.

18. The mobile device of claim 17, wherein the action includes at least one action selected from the group comprising of: unlocking the mobile device, locking the mobile device, changing a profile mode of the mobile device, transmitting a current location of the mobile device, or emitting an audio sound.

19. The mobile device of claim 17, wherein the means for detecting the second sequence of events comprises means for receiving a sequence of communication events from another device.

20. The mobile device of claim 19, wherein the sequence of communication events includes a combination of at least one communication event selected from the group comprising of: a missed call, a received text message, or a received text message having a predefined string of text.

21. The mobile device of claim 19, further comprising:
means for maintaining, at the mobile device, a phone number of a user-defined trusted device, wherein the means for performing the action at the mobile device comprises means for performing the action only if the sequence of communication events are received from the phone number of the trusted device.

22. The mobile device of claim 17, wherein the user-defined sequence of events comprises user actions performed directly to the mobile device while the mobile device is locked.

23. The mobile device of claim 22, wherein the mobile device is configured to unlock in response to a passcode entered via a lock screen of the mobile device, and wherein the user-defined sequence of events includes user actions other entering the passcode.

24. The mobile device of claim 23, wherein the user-defined sequence of events comprises at least one user action selected from the group comprising of: pressing a power button, pressing a home button, toggling a silent mode switch, pressing an increase volume button, pressing a decrease volume button, enabling or disabling an airplane mode via a virtual button, enabling or disabling a Wi-Fi mode via a virtual button, enabling or disabling a Bluetooth mode via a virtual button, enabling or disabling a do not disturb mode via a virtual button, enabling or disabling a screen orientation lock via a virtual button, adjusting a screen brightness via virtual slider, enabling or disabling a flashlight mode via a virtual button, launching a timer application via a virtual button, launching a calculator application via a virtual button, launching a camera application via a virtual button, setting the screen brightness to 100% via the virtual slider, setting the screen brightness to 0% via the virtual slider, or taking a screen shot by simultaneously pressing one or more physical peripheral buttons.

25. A non-transitory computer-readable storage medium including program code stored thereon, the program code comprising instructions to direct a mobile device to:
maintain, at the mobile device, data representative of a user-defined sequence of events, the user-defined sequence of events associated with an action to be performed by the mobile device, wherein the user-defined sequence of events comprises multiple events and a particular order of occurrence of the multiple events in order to trigger the associated action;
detect, at the mobile device, a second sequence of events;
compare the second sequence of events to the user-defined sequence of events; and
perform, at the mobile device, the action associated with the user-defined sequence of events in response to the second sequence of events matching the user-defined sequence of events.

26. The non-transitory computer-readable storage medium of claim 25, wherein the action includes at least one action selected from the group comprising of: unlocking the mobile device, locking the mobile device, changing a profile mode of the mobile device, transmitting a current location of the mobile device, or emitting an audio sound.

27. The non-transitory computer-readable storage medium of claim 25, wherein the second sequence of events comprises a sequence of communication events, and wherein the instructions to detect the second sequence of events comprises instructions to receive the sequence of communication events from another device.

28. The non-transitory computer-readable storage medium of claim 27, wherein the sequence of communication events includes a combination of at least one communication event selected from the group comprising of: a missed call, a received text message, or a received text message having a predefined string of text.

29. The non-transitory computer-readable storage medium of claim 11, wherein the program code further comprises instructions to direct the mobile device to:
maintain, at the mobile device, a phone number of a user-defined trusted device; and
perform the action only if the sequence of communication events are received from the phone number of the trusted device.

30. The non-transitory computer-readable storage medium of claim 25, wherein the user-defined sequence of events comprises at least one user action selected from the group comprising of: pressing a power button, pressing a home button, toggling a silent mode switch, pressing an increase volume button, pressing a decrease volume button, enabling or disabling an airplane mode via a virtual button, enabling or disabling a Wi-Fi mode via a virtual button, enabling or disabling a Bluetooth mode via a virtual button, enabling or disabling a do not disturb mode via a virtual button, enabling or disabling a screen orientation lock via a virtual button, adjusting a screen brightness via virtual slider, enabling or disabling a flashlight mode via a virtual button, launching a timer application via a virtual button, launching a calculator application via a virtual button, launching a camera application via a virtual button, setting the screen brightness to 100% via the virtual slider, setting the screen brightness to 0% via the virtual slider, or taking a screen shot by simultaneously pressing one or more physical peripheral buttons.
